(19) United States
(12) Patent Application Publication
(10) Pub. No.: US 2022/0405758 A1
(43) Pub. Date: Dec. 22, 2022

(54) ARTIFICIAL INTELLIGENCE FOR FINDING DECEPTIVE MERCHANTS IN RECURRING TRANSACTIONS

(71) Applicant: MASTERCARD INTERNATIONAL INCORPORATED, Purchase, NY (US)

(72) Inventors: Smriti GUPTA, New Delhi (IN); Siddhartha ASTHANA, Ghaziabad (IN); Ankur ARORA, New Delhi (IN); Hardik WADHWA, Gurgaon (IN); Siddharth VIMAL, Chandigarh (IN)

(73) Assignee: MASTERCARD INTERNATIONAL INCORPORATED, Purchase, NY (US)

(21) Appl. No.: 17/353,344

(22) Filed: Jun. 21, 2021

(51) Int. Cl. G06Q 20/40; G06N 3/04; G06K 9/62

(52) U.S. Cl. CPC G06Q 20/4016; G06Q 20/407; G06N 3/0454; G06K 9/6284; G06K 9/6215

(57) ABSTRACT

The disclosure herein relates to AI-based methods and systems of using machine-learning to identify deceptive merchants in payment transactions such as recurring payment transactions. For example, the AI-based systems and methods may train and use an aggregate merchant matcher based on entity matching to identify merchant identifiers and/or acquirers that may be used by a merchant, train and use transaction classifiers to classify transactions as deceptive, recognize merchants based on an N-density aware transaction embedding learned from transaction data, and train and use a merchant classifier to classify merchants as deceptive.

### BACKGROUND

A recurring payment transaction is a transaction in which a cardholder may authorize a merchant to store the cardholder's payment card credentials for recurring payments. The payments may be made as-needed or periodically, such as on a monthly, quarterly, or annual basis. In some instances, an issuer may request a payment network to cancel payment transactions (such as a recurring payment transactions) originating from a given merchant identifier and acquirer. For example, the cardholder may ask the issuer to decline recurring payment requests from a merchant to be paid from the payment account. The issuer may transmit a request to the payment network to add the merchant identifier, acquirer identifier, and payment account identifier to a payment cancelation service listing. The payment network may thereafter decline a payment transaction based on the payment cancelation service listing.

However, because merchants may use multiple merchant identifiers and different acquirers, it may be difficult to cancel a payment transaction based on a merchant identifier and/or an acquirer identifier supplied by the issuer. For instance, the merchant may resubmit a declined payment transaction using a different merchant identifier and/or a different acquirer. Furthermore, a merchant may use other combinations of transaction parameters that may result in approval of a payment transaction that should otherwise be declined. To this end, the merchant may employ sophisticated techniques, including optimization and machine-learning, to determine an optimal transaction route. The optimal transaction route may include combinations of transaction parameters to elicit an approval that should otherwise not be made. Some of these merchants may do so to intentionally to circumvent canceled payment requests, while others may do so without such intent. These and other issues may exist for identifying payment transactions that should be declined subject to a request for payment cancelation and identifying deceptive merchants that resubmit such payment transactions with intent to circumvent the cancelations.

### BRIEF DESCRIPTION OF THE DRAWINGS

Features of the present disclosure may be illustrated by way of example and not limited in the following figure(s), in which like numerals indicate like elements, in which:

FIG. 1 illustrates an example of a system environment that includes an Artificial Intelligence (“AI”)-based system to identify deceptive merchants in payment transactions;

FIG. 2 illustrates an example of training and using an aggregate merchant matcher;

FIG. 3 illustrates an example of training a transaction classifier based on a generative adversarial network;

FIG. 4 illustrates an example of recognizing merchants based on an N-class density aware transaction embedding;

FIG. 5 illustrates an example of training a classifier based on a 2-class density aware embedding;

FIG. 6 illustrates a data flow of determining whether to approve a recurring payment transaction based on the merchant aggregation, transaction classifier, merchant recognition, and/or merchant classifier;

FIG. 7 illustrates an example of a computer system that may be implemented by devices illustrated in FIG. 1;

FIG. 8 illustrates an example of an AI-based method of applying machine-learning to process recurring payment transactions; and

FIG. 9 illustrates an example method of classifying merchants.

### DETAILED DESCRIPTION

The disclosure herein relates to AI-based methods and systems of using machine-learning to identify deceptive merchants in recurring payment transactions. A deceptive merchant may refer to a merchant that alters one or more transaction parameters in an intentional effort to circumvent a payment cancelation request for a transaction that should otherwise be declined. For example, a deceptive merchant may alter a merchant identifier, acquirer, time (which may refer to a date and/or clock time) of payment submission, and/or other transaction parameter in an effort to obtain an approval for a payment transaction, such as a recurring payment transaction, that has been canceled by a cardholder. Due in part to the large volume of payment transactions and the particular data issues introduced by modern electronic payment systems, identifying a deceptive merchant in a particular transaction may present computational challenges.

For example, the use of multiple merchant identifiers and/or acquirers by a merchant may present a complex entity matching problem. Identifying a given transaction from among a large number of transactions as being deceptive to potentially inform whether or not a merchant that submitted the transaction is deceptive may be problematic when processed in isolation. Recognizing merchant identifiers involved in deceptive transactions may be difficult given the number of merchants, and determining whether the recognized merchants are deceptive versus exhibiting bad behavior presents a challenging classification task. Further compounding the issues, the foregoing and other computational decisioning may be made in the context of transaction processing in a payment network, which may require low latency and high throughput.

The AI-based systems and methods may employ various machine-learning techniques to facilitate identification of deceptive merchants. For example, the AI-based systems and methods may train and use an aggregate merchant matcher based on entity matching to identify merchant identifiers and/or acquirers that may be used by a merchant, train and use transaction classifiers to classify transactions as deceptive, recognize merchants based on an N-density aware transaction embedding learned from transaction data, train and use a merchant classifier to classify merchants as deceptive, and/or perform other AI-based tasks.

The aggregate merchant matcher may be trained to match merchant identifiers that refer to a unique merchant, which may be identified by an aggregate merchant identifier. The system may also match acquirer identifiers that identify acquirers to the aggregate merchant identifier by virtue of the co-appearance of a merchant identifier and an acquirer identifier in a given transaction. The system may store, in association with the aggregate merchant identifier, the matched merchant identifiers and acquirer identifiers in a merchant-acquirer pool. When a payment cancelation request is made with respect to a payment account, and a merchant identifier that is matched to an aggregate merchant identifier is involved in a transaction that is accordingly declined, subsequent payment transactions that include any combination of the matched merchant identifiers and acquirer identifiers for the unique merchant identifier may be blocked. Thus, by matching merchant identifiers used by a merchant through entity matching using machine-learning techniques, the use of different merchant identifiers and/or acquirers by a merchant to avoid decline messages may be mitigated.

In some examples, certain merchant identifiers and/or acquirer identifiers may not be detected based on the merchant-acquirer pool, in which case a transaction that should be declined subject to the payment cancelation request may be approved. This may occur for novel merchant identifiers, when a merchant identifier is not yet involved in a declined payment transaction, or other reasons. As such, the system may train and use a transaction classifier to classify incoming payment transactions as a deceptive transaction that should be declined. Deceptive transactions may be submitted by merchants to intentionally (in which case the merchant may be deemed to be deceptive) or unintentionally (in which case the merchant may be deemed to be non-deceptive, but exhibiting bad behavior) circumvent payment cancelation requests. It should be noted that a merchant may be identified as being deceptive based at least in part when the merchant submits a deceptive transaction. However, merely because a merchant submits a deceptive transaction does not mean that the merchant should be classified as deceptive.

The transaction classifier may be trained based on training data that includes transaction data of payment transactions labeled as deceptive. A deceptive transaction may refer to a payment transaction originating from a merchant to be paid by a payment account even though the payment transactions from the merchant have been requested to be canceled. In some examples, for training purposes, transactions that were subject to chargebacks may be labeled as deceptive transactions in the training data. In some of these examples, non-deceptive transaction labels may be absent from the training data due to an imperfect data condition in the transaction data. The imperfect data condition may arise because payments that were supposed to be canceled but were still authorized may not necessarily be subject to chargebacks (because the cardholder may not have noticed the improper authorization or may not have initiated a chargeback, for example). Thus, transactions that were not subject to chargebacks may not necessarily reflect non-deceptive transactions. In these examples, the transaction classifier may be a one-class classifier (“OCC”) trained on a single class representing deceptive transactions—that is, transactions subject to chargeback.

In some examples, the transaction classifier may be trained based on a generative adversarial network (“GAN”) in which two networks, a generator and a discriminator, are trained simultaneously in an adversarial process. The generator may generate an output that introduces deviations from the training data (which represent deceptive transactions). The discriminator may estimate a probability that the output of the generator represents the training data rather than deviations from the training data. In some examples, the discriminator may generate an output that includes the probability, and the output of the discriminator may be fed back to the generator. In some examples, the output of the discriminator may include data indicating reasons for the determination made by the discriminator. The generator may use the output the of discriminator to further improve the way in which the training data is modified to introduce deviations. The process may continue until the discriminator is able to distinguish, with a predefined level of confidence, whether or not input data represents the training data. If the input data is representative of the training data, then no anomaly is detected in the input data (and the input data is classified as a deceptive transaction). On the other hand, if the input data is not representative of the training data, then an anomaly relative to the training data is detected (and the input data is classified as a non-deceptive transaction).

If payment transactions are classified as deceptive transactions, the system may identify merchants that submitted the payment transactions. For example, a merchant recognizer may be trained to recognize merchants based on an N-class density aware transaction embedding, where N is the number of known merchants associated with payment cancelation requests. Classification of a merchant into a merchant class, from among the N-classes, may refer to determining that the merchant is identified as a merchant represented by the merchant class.

Once the merchant has been recognized, the system may classify the merchant as a deceptive merchant or non-deceptive merchant. For example, the system may train and use a merchant classifier to generate a 2-class density aware embedding for deceptive and non-deceptive classes. In one example, the merchant classifier may generate, for the recognized merchant, a deceptive merchant Word Mover's Distance (“WMD”) score and a non-deceptive WMD score based on the 2-class density aware embedding. For example, the deceptive WMD score may reflect a level of similarity of the recognized merchant to deceptive merchants and the non-deceptive WMD score may reflect a level of similarity of the recognized merchant to non-deceptive merchants. The merchant classifier may generate a classifier score based on the deceptive merchant WMD score and non-deceptive WMD score. If the classification score is greater than a threshold value, then the merchant classifier may classify the merchant as a deceptive merchant.

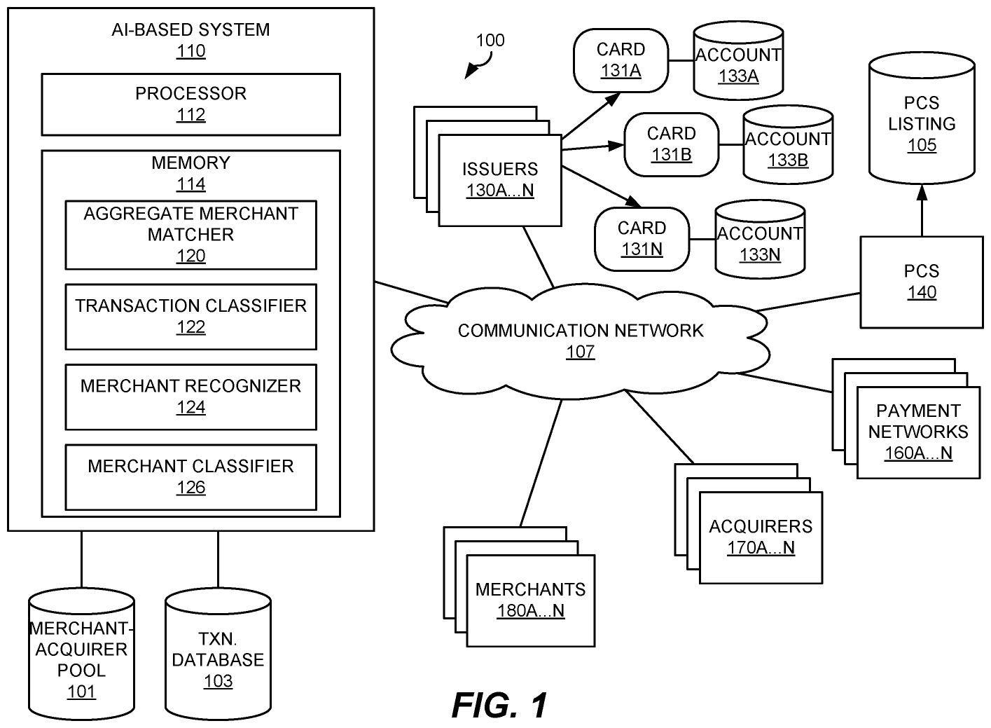

Having described an overview of various system operations, attention will now turn to a description of a system to generate the transaction authorization decisions. For example, FIG. 1 illustrates an example of a system environment 100 that includes an AI-based system 110 to identify deceptive merchants in payment transactions. In particular, the AI-based system 110 may predict whether a recurring payment transaction from a merchant 180 using an acquirer 170 has been requested to be canceled. In some examples, AI-based system 110 may include self-learning and self-reinforcement mechanisms to refine modeling of transactions and merchants. For purposes of illustration, in the examples that follow, modeling may be described with reference to modeling transactions and merchants in the context of recurring payment transaction cancelations. However, the disclosure may relate to training, validating, and using ML classifiers for modeling transactions and merchants in the context of other types of transactions subject to a cancelation request or that should otherwise be declined.

The system environment 100 may include, among other things, a merchant-acquirer pool 101, a transaction database 103, one or more issuers 130, a payment cancellation service (“PCS”) 140, one or more payment networks 160, one or more acquirers 170, one or more merchants 180, and/or other components. As used herein, the term “transaction” or “payment transaction” may refer to a request for payment by a merchant 180 through a payment network 160. Such transactions may be initiated by an acquirer 170 on behalf of the merchant through an authorization request message transmitted by the acquirer 170 to the payment network 160, which in turn may request authorization from the issuer 130.

The merchant-acquirer pool 101 may include a database that stores a listing of blocked merchant identifiers that identify merchants 180, acquirers 170 used by merchants 180, and/or other information relating to merchants 180 that are to receive authorization decline messages for payment transactions that a payment account 133 for which payment cancelation has been canceled. The transaction database 103 may include a database that stores information relating to transactions submitted and processed through a payment network 160, chargeback data indicating chargebacks of payment transactions, and/or other data from transactions submitted to a payment network 160 for payment.

An issuer 130 may issue a plurality of cards 131 (illustrated as cards 131A,131B, . . . , 131N). Cards 131 may refer to a payment card such as credit cards, debit cards, and other payment devices such as digital wallets associated with a corresponding payment account 133. Thus, for purposes of examples described herein, use of a card 131 in a payment transaction may include use of any such payment devices that cause a payment from the payment account 133.

An issuer 130 may receive, from a cardholder, a request to cancel certain types of payment transactions, such as recurring payment transactions, originated from particular merchants 180. For example, the cardholder may have canceled a monthly subscription or installment payment with a particular merchant 180 and may wish to ensure that any recurring payment transaction associated with the monthly subscription are declined. The issuer 130 may transmit, to the PCS 140, a request to cancel the recurring payment transaction with a payment account identifier and one or more cancelation parameters. The payment account identifier may identify a payment account 133 used to pay for the (now canceled) monthly subscription. An example of a payment account identifier may include a primary account number (“PAN”). The one or more cancelation parameters may include a merchant identifier, an acquirer identifier, a payment amount or range of amounts, a payment date or range of dates, and/or other cancelation parameters. The merchant identifier may identify the particular merchant 180. An example of the merchant identifier may include a card acceptor identifier. The acquirer identifier may identify an acquirer 170 used by the particular merchant 180 for the recurring payment transactions. An example of the acquirer identifier may include an acquirer Interbank Card Association (“ICA”) identifier.

The PCS 140 may store an association of the payment account identifier and the cancelation parameters. For example, the PCS 140 may store the association as an entry in a payment cancellation service (“PCS”) listing. An entry in a PCS listing may be made responsive to other events as well. For example, one or more chargebacks in which a cardholder requests a refund of an authorized payment transaction may result in the creation of an entry in the PCS listing 105 for a payment account 133 and merchant 180 subject to the chargeback. After the PCS listing 105 entry is made, the particular merchant 180 may, mistakenly or intentionally, submit and/or resubmit a request for a recurring payment transaction through its acquirer 170 identified by the acquirer identifier. Such submission may be at a predefined time, such as at a regular monthly time. Responsive to the request for the recurrent payment transaction, the acquirer 170 may transmit an authorization request message to the payment network 160, which may operate or otherwise consult the PCS 140. An example of a payment network 160 may include the Mastercard® network.

The PCS 140 may access the PCS listing 105, determine that recurring payment transactions for the payment account 133 involving the acquirer identifier and merchant identifier are to be denied, and transmit an authorization decline message to the acquirer 170 with an appropriate response code that indicates reasons for the authorization decline message. An example of a response code may include a merchant advice code (“MAC”). The acquirer 170 may transmit, to the merchant 180, an indication that the recurring payment transaction was declined. Such indication may or may not include the response code from the payment network 160 depending on the configuration or policy of the acquirer 170.

Some merchants 180 that receive an authorization decline message for recurring payment transactions may resubmit the declined request one or more times. In some of these examples, the merchants 180 may resubmit a previously declined request with different transaction parameters. The transaction parameters may include a merchant identifier, use of an acquirer 170 resulting in a different acquirer identifier, a time such as time of day or day of the week of submission, and/or other transaction parameter that specifies a payment transaction. In some examples, these merchants 180 may continue such resubmission until an authorization is received. In some of these examples, the merchants 180 may employ automated systems to automatically determine transaction routing by modifying one or more transaction parameters in an effort to receive an approval. Depending on the cancelation parameters stored in the PCS listing 105, some of these resubmission requests may be successful, resulting in an improper approval.

For example, referring to the previous example of an entry in the PCS listing 105, if the merchant 180 uses a different acquirer 170 for a resubmitted request, the PCS 140 may not recognize the merchant identifier and different acquirer identifier combination and may therefore not decline the resubmitted request. Examples of other modifications that may result in an improper authorization may include use of a different merchant identifier (such as a different card accept identifier), submission at a different time of day or day of week, and/or other modifications that would deviate from the cancelation parameters. It should be noted that the cancelation parameters may be unknown to the merchant 180. However, trying different modifications may in effect discover which cancelation parameters that, when modified, may result in an approval. This problem may be exacerbated when merchants 180 employ automated systems to discover optimal transaction routing that modifies acquirer, date, time, and/or other value to maximize the probability that a request for a payment transaction will be authorized.

To mitigate these and other issues, the AI-based system 110 may be programmed to classify a transaction and merchant through various machine-learning techniques. For example, the AI-based system 110 may include a processor 112, a memory 114, an aggregate merchant matcher 120, a transaction classifier 122, a merchant recognizer 124, a merchant classifier 126, and/or other components. The processor 112 may be a semiconductor-based microprocessor, a central processing unit (CPU), an application specific integrated circuit (ASIC), a field-programmable gate array (FPGA), and/or other suitable hardware device. Although the AI-based system 110 has been depicted as including a single processor 112, it should be understood that the AI-based system 110 may include multiple processors, multiple cores, or the like. The memory 114 may be an electronic, magnetic, optical, or other physical storage device that includes or stores executable instructions. The memory 114 may be, for example, Random Access memory (RAM), an Electrically Erasable Programmable Read-Only Memory (EEPROM), a storage device, an optical disc, and the like. The memory 114 may be a non-transitory machine-readable storage medium, where the term “non-transitory” does not encompass transitory propagating signals.

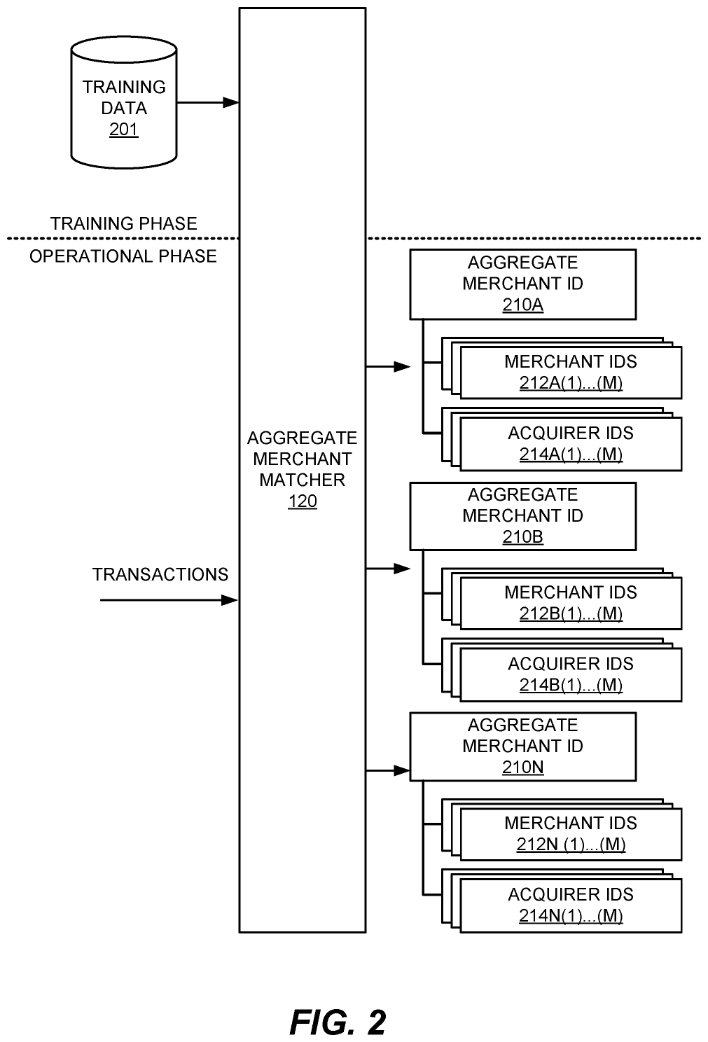

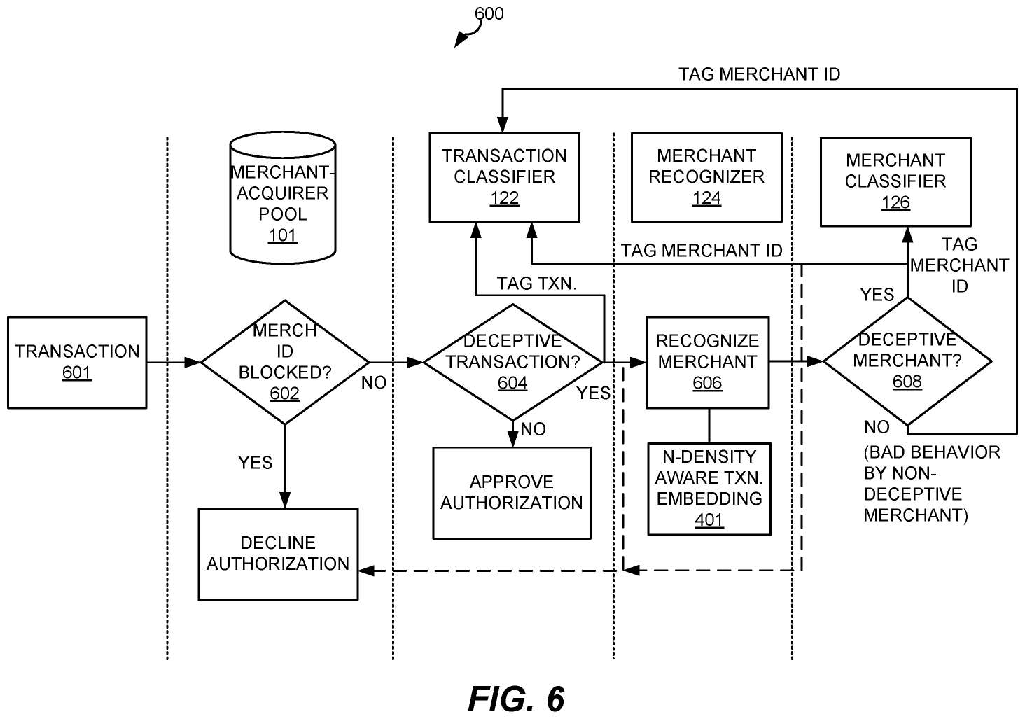

The aggregate merchant matcher 120, the transaction classifier 122, the merchant recognizer 124, and/or the merchant classifier 126 may each be implemented as instructions that program the processor 112. Alternatively, or additionally, the aggregate merchant matcher 120, the transaction classifier 122, the merchant recognizer 124, and/or the merchant classifier 126 may each be implemented in hardware. Examples of the aggregate merchant matcher 120, the transaction classifier 122, the merchant recognizer 124, and the merchant classifier 126 will refer to FIGS. 2-5, followed by a discussion of an example data flow used by the AI-based system 110 in FIG. 6. FIGS. 2-6 may refer back to features of FIG. 1 to describe system components.

Entity Matching for Merchant Aggregation

FIG. 2 illustrates an example of training and using an aggregate merchant matcher such as the aggregate merchant matcher 120 illustrated in FIG. 1. During a training phase, the aggregate merchant matcher 120 may be trained on training data 201 to identify merchant identifiers 212 and acquirers 170 used by a merchant 180. For example, the aggregate merchant matcher 120 may be trained to use entity matching to link or otherwise cluster merchant identifiers 212 together to determine which ones of the merchant identifiers 212 refer to a single merchant 180. Such linked or clustered merchant identifiers 212 may be referred to as being matched. Entity matching may include an identification of relevant features, which may be present in the training data 201, that are predictive of whether or not a given pair of merchant identifiers 212 should be matched.

The training data 201 may include data from the PCS 140, such as the PCS listing 105, transaction data from the transaction database 103, and/or other data. In some examples, the training data 201 may include merchant identifiers 212 known to correspond to unique merchants 180. For example, a given merchant 180 may be empirically known to use a certain set of merchant identifiers 212. The training data 201 may include transaction records that are labeled to indicate that such merchant identifiers 212 are to be grouped with one another. The training data 201 may further include various features of transaction data that may be indicative of merchant identifiers 212 to be matched. In other words, the training data 201 may include various features that may be predictive of whether or not a given merchant identifier 212 should be matched another merchant identifier 212 to indicate they both belong to the given merchant 180. Examples of features may include merchant location indications associated with merchant identifiers 212, spend amounts, time of transactions, and/or other data that may indicate merchant identifiers 212 are to be matched.

The aggregate merchant matcher 120 may be trained with deep learning techniques that may identify the features and/or feature weights. For example, the aggregate merchant matcher 120 may be trained via a neural network. A neural network may refer to a computational learning system that uses a network of neurons to translate a data input of one form into a desired output. A neuron may refer to an electronic processing node implemented as a computer function, such as one or more computations. The neurons of the neural network may be arranged into layers. Each neuron of a layer may receive as input a raw value (such as the feature value), apply a network weight to the raw value, and generate an output via an activation function. The activation function may include a log-sigmoid function, hyperbolic tangent, Heaviside, Gaussian, SoftMax function and/or other types of activation functions to arrive at an output classification. For example, the output classification may include a classification of whether or not an input merchant identifier 212 is to be matched with one or more other merchant identifiers 212.

During an operational phase, the aggregate merchant matcher 120 may take transaction data as input and generate match predictions based on the relevant features and/or feature weights. For example, the aggregate merchant matcher 120 may generate a match score between a merchant identifier 212 in the input transaction data and other merchant identifiers 212 known to the system, such as merchant identifiers 212 stored in the PCS listing 105, merchant-acquirer pool 101, and/or the transaction database 103. The match score may represent a probability that a first merchant identifier 212 should be matched with one or more other merchant identifiers 212. The match score may be based on one more features and their respective feature weights. For example, merchant locations that are exactly the same between two merchant identifiers 212 may indicate a higher probability that the two merchant identifiers 212 should be matched as compared to merchant locations that are partially or not the same. Similarly, spend amounts that are exactly the same between two merchant identifiers 212 may indicate a higher probability that the two merchant identifiers 212 should be matched as compared to spend amounts that are not the same (where the amount of deviation lowers the probability of match). The aggregate merchant matcher 120 may similarly compare other relevant features. When more than one feature is used, the aggregate merchant matcher 120 may weight each feature according to its feature weight and then combine the weighted feature values to generate the similarly metric.

From a data structural standpoint, each unique merchant 180 may be identified by an aggregate merchant identifier 210 (illustrated as aggregate merchant identifiers 210A . . . N). The aggregate merchant matcher 120 may use aggregate merchant identifiers 210 to respectively identify unique merchants 180. For example, an aggregate merchant identifier 210A may identify a merchant 180A, an aggregate merchant identifier 210B may identify a merchant 180B, and an aggregate merchant identifier 210N may identify a merchant 180N, and so forth. An aggregate merchant identifier 210 may be associated with a merchant's name. For example, a merchant 180A named “ABC company” may be identified by an aggregate merchant identifier 210A.

Matched merchant identifiers 212 may then be aggregated and associated with a corresponding aggregate merchant identifier 210. For example, the merchant 180A may use one or more merchant identifiers 212A(1) . . . (M) to submit payment transactions. Likewise, the merchant 180B may use one or more merchant identifiers 212B(1) . . . (M) and the merchant 180N may use one or more merchant identifiers 212N(1) . . . (M) to submit payment transactions to submit payment transactions. The merchant 180A . . . N may each use one or more acquirers 170 identified by respective acquirer identifiers 214 as well. For example, the merchant 180A may use one or more one or more acquirers 170 each identified by acquirer identifiers 214A(1) . . . (M), the merchant 180B may use one or more one or more acquirers 170 each identified by acquirer identifiers 214B(1) . . . (M), and the merchant 180N may use one or more one or more acquirers 170 each identified by acquirer identifiers 214N(1) . . . (M), and so forth. It should be noted that each merchant 180A . . . N may use different numbers of merchant identifiers 212 and/or acquirers 170 relative to one another.

The aggregate merchant matcher 120 may be trained to link or otherwise cluster together merchant identifiers 212 that correspond to a merchant 180 identified by an aggregate merchant identifier 210. The aggregate merchant matcher 120 may also keep track of the acquirer identifier 214 and the merchant identifier 212 in a given transaction. Thus, if a merchant 180A identified by an aggregate merchant identifier 210A uses a merchant identifier 212A(1) and an acquirer 170 identified by an acquirer identifier 214A(2) for a first transaction, the aggregate merchant matcher 120 may link the acquirer identifier 214A(2) with the aggregate merchant identifier 210A. In this manner, if the merchant 180A identified by the aggregate merchant identifier 210A uses the merchant identifier 212A(1) and another acquirer 170 identified by an acquirer identifier 214A(1) for a second transaction, then the aggregate merchant matcher 120 may still recognize the combination of merchant identifier 212A(1) and acquirer identifier 214A(1) as one that may be used by the aggregate merchant matcher 120, whether or not the particular combination of the merchant identifier 212A(1) and the acquirer identifier 214A(1) was used by the merchant 180A.

It should be noted that merchant aggregation may be split across multiple levels such as across channels, key channels, and/or system-wide for all merchant identifiers across all channels. For example, merchant aggregation may be performed by channel such as by matching merchant identifiers including online payments, brick-and-mortar payments, card-on-file payments, and/or other channels. To illustrate, merchants that use online payments may be matched together with other merchants that use online payments. Some of these channels may be deemed to be key channels on which to perform aggregation. In this manner, merchant aggregation may be focused on particular channels or system-wide.

In some examples, the matched merchant identifiers 212 and acquirer identifiers 214 may be pooled to generate the merchant-acquirer pool 101. For example, when a merchant identifier 212 of a merchant 180 is associated with a blocked transaction in the PCS listing 105 for a payment account 133, the merchant identifiers 212 and acquirer identifiers 214 for the aggregate merchant identifier 210 in merchant-acquirer pool 101 may be consulted to block subsequent resubmissions involving known merchant identifiers and/or acquirers used by the merchant. Subsequently, combinations of merchant identifier 212 and acquirer identifier 214 for the merchant 180 (identified by an aggregate merchant identifier 210) may be blocked from payment transactions directed to the payment account 133. Thus, merchant aggregation may provide a solution to the problem that merchants 180 may optimize transaction routing with different merchant identifiers and/or through different acquirers 170, with or without intent to deceive, to achieve payment authorizations for payment transactions that should be blocked based on the PCS listing 105.

Transaction Classification

In some examples, some merchant identifiers and/or acquirer identifiers may not be detected based on the merchant-acquirer pool 101. For example, a merchant identifier 212 of a payment transaction may not be in the merchant-acquirer pool 101. This may occur for novel merchant identifiers or other reasons. To further improve performance of determining when a given payment transaction that should be denied based on the PCS listing 105 but may otherwise be errantly authorized, the AI-based system 110 may classify incoming payment transactions. In these instances, to determine whether or not to authorize the payment transaction involving a payment account in the PCS listing 105, the payment transaction may be classified as being “deceptive.” An example of a deceptive transaction may include a transaction submitted or resubmitted by a merchant 180 for payment from a payment account 133 when the payment account and a merchant identifier that identifies the merchant 180 and/or the acquirer identifier used by the merchant is in the PCS listing 105. Such a deceptive transaction may follow a previously declined request for payment by the merchant 180 from the payment account 133 and use a different combination of transaction parameters than the initial declined request.

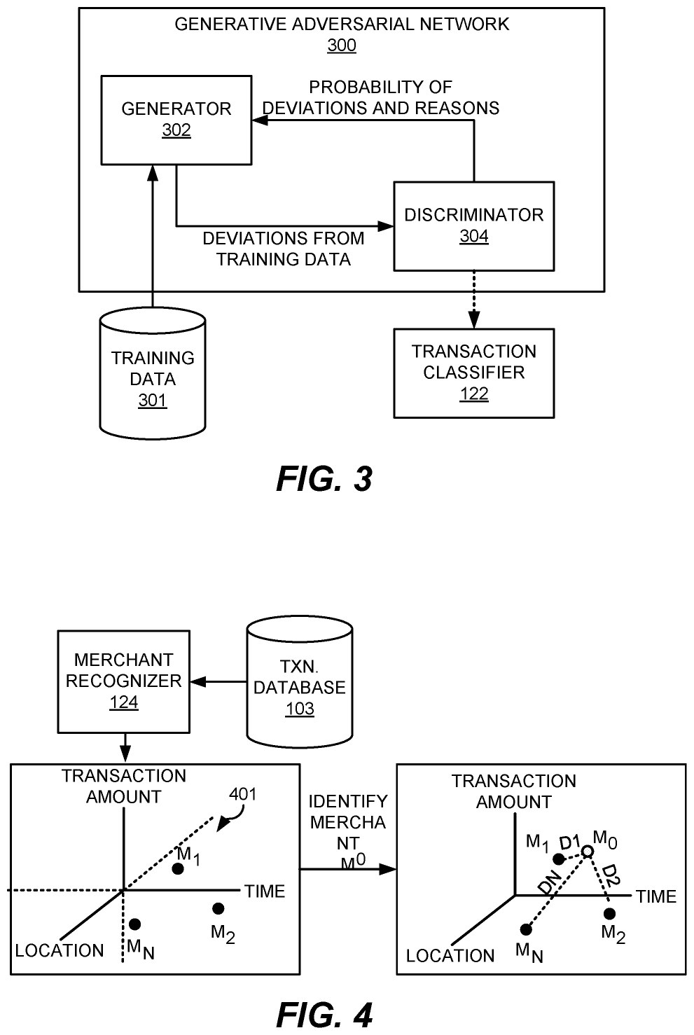

The AI-based system 110 may train and use a transaction classifier 122 to classify transactions as a deceptive transaction. For example, FIG. 3 illustrates an example of training and using a transaction classifier 122 based on a GAN 300. Other machine-learning training may be used. A GAN 300 may refer to a framework for the estimation of generative models in which two models, a generator 302 and a discriminator 304, are trained simultaneously in an adversarial process. The generator 302 may generate an output that introduces deviations from the training data 301. The discriminator 304 may estimate a probability that the output of the generator 302 represents the training data 301 rather than deviations from the training data 301. In other words, the discriminator 304 may determine whether input data (the output of the generator 302) represents the training data 301 or is anomalous and does not represent the training data 301. In some examples, the discriminator 304 may generate an output that includes the probability, and the output of the discriminator 304 may be fed back to the generator 302.

In some examples, the output of the discriminator 304 may include data indicating reasons for the determination made by the discriminator 304. For example, the output of the discriminator 304 may include features and feature weights used by the discriminator 304 used to generate the probability. The generator 302 may use the output the of discriminator 304 to further improve the way in which the training data 301 is modified to introduce deviations. For example, the generator 302, if the generator 302 determines that the probability determined by the discriminator 304 was accurate, the generator 302 may attempt to change another feature or otherwise introduce deviations from the training data 301 in another way. On the other hand, if the generator 302 determines that the probability determined by the discriminator 304 was inaccurate, the generator 302 may continue to introduce deviations to the particular features relied upon by the discriminator 304 to make its errant determination.

The process may continue until the discriminator 304 is able to distinguish, with some predefined level of confidence, whether or not input data represents the training data 301. If the input data is representative of the training data 301, then no anomaly is detected in the input data. On the other hand, if the input data is not representative of the training data 301, then an anomaly relative to the training data 301 is detected. Thus, the discriminator 304 may be trained to detect anomalies with respect to the training data 301.

In some examples, the training data 301 may include transaction data of payment transactions labeled as deceptive transactions. For example, payment transactions may be labeled as deceptive if the payment transaction was subject to a chargeback, which results from a refund request from a cardholder. The transaction data may further include features of the deceptive transactions that may have a predictive relationship to deceptive transactions. Thus, the generator 302 may generate output that introduces deviations from data of the deceptive transactions. The discriminator 304 (the transaction classifier 122 after training by the GAN 300) may be trained to detect whether or not input data of a payment transaction being assessed is representative of deceptive transactions in the training data 301. If the input data is representative of the training data 301, then the payment transaction may be determined to be deceptive. On the other hand, if the transaction classifier 122 determines that the input data is not representative of the training data 301, then the payment transaction may be determined to be non-deceptive. Such determination may be based on the probability that the input data is representative of the training data 301. For example, the probability may be compared to a threshold probability that may be predefined and/or configured based on empirical observations of known deceptive transactions and their corresponding probabilities of being representative of the training data 301.

The generator 302 may introduce deviations to various features of the training data 301. The features may include transaction-level features, merchant identifier-level features, acquirer identifier-level features, card number level features, chargeback data, and/or other aspects of a payment transaction. The transaction-level features may include a merchant Uniform Resource Locator (“URL”), spend (since recurring payment transactions may follow a spend pattern—such as a monthly $10 charge), time of transaction. The merchant identifier-level features may include spend, transactions, whether or not the merchant has entries the in PCS listing 105, number of deceptive transactions in one or more periods (such as in the last 7, 14, or 30 days)—where deceptive transaction classifications are used for feedback and reinforcement learning, location of deceptive transactions, and/or other features relating to a merchant. The acquirer identifier-level features may include spend, transactions, whether or not the acquirer has entries in the PCS listing 105, number of deceptive transactions in one or more periods, and/or other features relating to an acquirer. The card number-level features may include a location of the issuer 130 (such as country of the issuer), whether or not the card number (such as account number of the payment account 133) has entries in the PCS listing 105, number of deceptive transactions involving the card number in one or more periods, and/or other features relating to the card number. In some examples, the generator 302 may simulate actions that a merchant 180 may take in an effort to automatically select optimal transaction routing by introducing changes to features relating to optimal transaction routing (such as a time of the transaction or acquirer used.

TABLE 1
Sample training data 301 that includes chargeback data. The data in table
1 is provided for illustrative, and not necessarily limiting purposes, as other data fields may be
used in addition or instead of the below. As illustrated, each row in Table 1 illustrates data for a
payment transaction that was subject to a chargeback, and is therefore labeled as a deceptive
transaction. The data may include a time (date) of the payment transaction, a reason code indicating
a reason for declining the payment transaction, a message string indicating a description of the
reason, a location identifier (ID) indicating a location of a merchant 180 that submitted the payment
transaction, an aggregate merchant ID that identifies the merchant 180 (including merchant name
and channel used by the merchant), and an amount of the payment transaction.

| | | | | Aggregate | |
|---|---|---|---|---|---|
| | | | | Merchant | |
| Time (date) | Reason code | Message | Location ID | ID + data | Amount |
| YYYY-MM-DD | 4840 | No Cardholder | 123456789 | 112233445 | 9.99 |
| | (Fraudulent) | Authorization | | ABC co. | |
| | | | | (online) | |
| YYYY-MM-DD | 4839 | No Cardholder | 123456789 | 112233445 | 9.99 |
| | (Fraudulent) | Authorization | | ABC co. | |
| | | | | (online) | |
| ... | ... | ... | ... | ... | ... |
| YYYY-MM-DD | 4839 | No Cardholder | 123456789 | 112233445 | 14.99 |
| | (Fraudulent) | Authorization | | ABC co. | |
| | | | | (online) | |

In some examples, detecting payments that were canceled and yet still authorized may be difficult due to an imperfect data condition in the transaction data. Such imperfect data condition may arise because payments that were supposed to be canceled but were still authorized may not necessarily be subject to chargebacks. Thus, a given payment that was authorized but not later subject to a chargeback does not necessarily mean that the payment was appropriate, making it difficult to train the transaction classifier 122 to detect “non-deceptive” transactions. Thus, these payment transactions would be an inappropriate target dataset to serve as labeled data indicating “non-deceptive” transactions. Put another way, a payment transaction that was not subject to a chargeback may be a false negative reporting of a deceptive transaction. As such, to address this potential imperfect data condition in transaction data, transactions subject to chargebacks may be used to positively identify deceptive transactions in the training data 301. In these examples, the transaction classifier 122 may be an OCC trained on a single class—that is, transactions subject to chargebacks.

Because of the way in which the OCC is trained, an anomaly may refer to a deviation from the probability that the input data belongs to the single classification—namely that the input data represents an inappropriate payment. Thus, speaking from a modeling perspective, the GAN 300 used to train the transaction classifier 122, which may be an OCC, may be used to detect anomalies from the training data 301, where such training data 301 represents deceptive transactions. An output of the transaction classifier 122 may be a probability that the input data represents a deceptive transaction. If the probability exceeds a threshold probability, then the input transaction data may be deemed to represent a deceptive transaction. It should be noted that the threshold probability may be predefined and/or refined based on empirical observations of deceptive transactions which may inform what the appropriate threshold value should be.

It should be noted that a binary or multi-class classifier may be used instead of an OCC, but this may be subject to potentially inaccurate data due to the aforementioned imperfect data condition. In other words, while one class representing deceptive transactions may be accurately trained, the other class representing appropriate transactions may be trained on data that may include non-deceptive transactions as well, rendering the model potentially less accurate in these instances.

Merchant Recognition

If payment transactions are classified as deceptive transactions, the AI-based system 110 may identify merchants 180 that submitted the payment transactions. For example, FIG. 4 illustrates an example of recognizing merchants based on an N-class density aware transaction embedding 401 (also referred to as “embedding 401” for convenience), where N is the number of known merchants 108 in the PCS listing 105. The merchant recognizer 124 may process transactions from the transaction database 103 to generate the embedding 401, which may be used to classify a merchant 180 into one of the N-classes. Classification of a merchant 180 into a merchant class of the N-classes may refer to determining that the merchant 180 is identified as the merchant for which the merchant class represents.

An embedding 401 may refer to vector (such as numerical) representations M_{1-N} of merchants 180 in the PCS listing 105. The vector representations M_{1-N} may be generated based on multiple dimensions such as spend, location (such as city of the merchant 180), and time, although other dimensions may be used. Each dimensional embedding may relate to a characteristic of the merchants 180. Merchants 180 that are more similar to one another with respect to a dimension will be closer to one another in the dimensional embedding. For example, merchants 180 whose locations are closer to one another will be closer to one another in the location embedding than merchants whose locations that are further away from one another. Merchants that have similar spend (transaction amount) will be closer to one another in the spend embedding than merchants having different spends. Merchants that have similar transaction times (time/date when transactions are submitted) will be closer to one another in the spend embedding than merchants having different transaction times.

In some examples, the merchant recognizer 124 may generate a vector representation M₀ of a merchant to be recognized from a payment transaction. The vector representation M₀ may be compared to each vector representation M_{1-N}. Such comparison may include a comparison of respective distances D_{1-N} between a centroid of M₀ and respective centroids of each vector representation M₁-M_{N}. The merchant recognizer 124 may classify the merchant represented by M₀ into a vector representation M_{1-N} having the smallest distance. For example, as illustrated, distance D₁ is the smallest distance. The merchant M₀ may accordingly be classified as a merchant represented by M₁. In some examples, to make the comparisons between centroids, the merchant recognizer 124 may convert each vector representation M_{0-N} into a single numeric value representative of the vector representation. For example, the merchant recognizer 124 may generate a dot product of each vector representation M₀-M_{N} and compare the dot product of M₀ with each of the dot products of M_{1-N}.

Merchant Classification

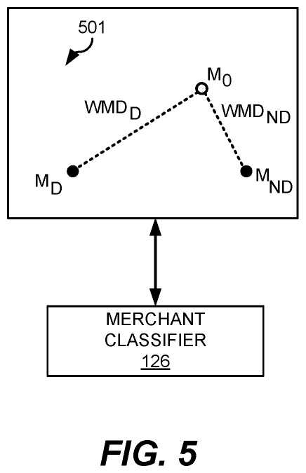

Once the merchant has been recognized, the AI-based system 110 may classify the merchant as a deceptive merchant or non-deceptive merchant. For example, referring to FIG. 5, the merchant classifier 126 may generate a 2-class density aware embedding 501 (also referred to as “embeddings 501”) for deceptive and non-deceptive classes. The dimensions for the 2-class density aware embedding may include data known about merchants, such as merchant location, times that the merchant submits transactions, payment amounts that the merchant submits transactions, payment accounts specified by merchants as payers, acquirers used, number of deceptive transaction submitted, number of times that the merchant has been deemed to be deceptive, and/or other information known about merchants. In one example, the merchant classifier 126 may generate, for the recognized merchant, a deceptive merchant WMD score and a non-deceptive WMD score. The 2-class density aware embedding 501 may be generated in a manner that is similar to the generation of the embedding 401 illustrated in FIG. 4, except that the embeddings 501 may represent a vector M_{D} representing deceptive merchants and a vector representing non-deceptive merchants M_{ND}. For example, deceptive and non-deceptive merchants may be labeled based on empirical observations and/or input from users. The data known about the deceptive and non-deceptive merchants may be used to generate the 2-class density aware embedding. Thus, M_{D} and M_{ND} may include vectors that respectively represent data known about deceptive and non-deceptive merchants. It should be noted that the merchant classifications may be continuously fed back to the merchant classifier 126, which may refine and improve M_{D} and M_{ND} over time.

The merchant classifier 126 may generate an embedding M₀ that includes a vector based on data known about the recognized merchant along the same dimensions as the dimensions used to generate M_{D} and M_{ND}. The merchant classifier 126 may generate a first similarity score between M₀ and M_{D} and a second similarity score between M₀ and M_{ND}. The first similarity score may represent a similarity between the recognized merchant and deceptive merchants. The second similarity score may represent a similarity between the recognized merchant and non-deceptive merchants. In some examples, the first and second similarity scores are each a WMD score. To generate a classification of the recognized merchant, the merchant classifier 126 may generate a classification score that represents which similarity score is stronger.

For example, the merchant classifier 126 may generate a classification score, C, based on the following:

$$C = \frac{WMD deceptive}{WMD non deceptive} , \qquad ( 1 )$$

in which:

WMD_{deceptive} is a deceptive merchant WMD score for a merchant (WMD D as illustrated in FIG. 5), and

WMD_{nondeceptive} is a non-deceptive merchant WMD score for the merchant (WMD_{ND} as illustrated in FIG. 5).

The merchant classifier 126 may compare the classification score, C, to a threshold value. If C is greater than the threshold value, then the merchant classifier 126 may classify the merchant as a deceptive merchant. Otherwise, if C is less than the threshold value, then the merchant classifier 126 may classify the merchant as a non-deceptive merchant. In some examples, the threshold value may be determined empirically based on known deceptive merchants. Deceptive merchants may be known when they are reported by relevant parties, such as issuers who report deceptive merchants, PCS listing 105 entries that include merchants having large numbers of chargebacks, and/or other sources of known deceptive merchants. The classification score, C, scores of each known deceptive merchant may be calculated to determine an appropriate threshold value that may be predictive of deceptive merchants. In some examples, the classification scores, WMD_{deceptive}, and/or MD_{nondeceptive} may be used as features and deceptive merchant identifiers may be used as labels in supervised machine-learning to discover an appropriate threshold level.

FIG. 6 illustrates a data flow 600 of determining whether to approve a recurring payment transaction based on the merchant aggregation, transaction classifier, merchant recognition, and/or merchant classifier. A transaction 601 may be received for processing, such as at a payment network 160. The transaction 601 may include a recurring payment transaction (including a subscription payment transaction), other credential on file transaction, and/or other type of payment transaction. In some examples, the transaction 601 may include or be associated with transaction parameters such as a payment account 133 for payment, a merchant identifier 212 of a merchant 180 that originated the transaction, an acquirer identifier 214 of an acquirer 170 that submitted the transaction 601 on behalf of the merchant 180, a payment amount, a time, a merchant location, and/or other details of the transaction 601.

The data flow 600 may proceed to 602, in which a determination of whether the merchant identifier 212 of the transaction 601 is blocked for the payment account 133 (such as when the payment account 133 is associated with a payment cancelation request in the PCS listing 105). For example, the merchant-acquirer pool 101 may be consulted to determine whether the merchant identifier 212 is in the merchant-acquirer pool 101 and/or whether the merchant identifier 212 and acquirer identifier 214 combination is in the merchant-acquirer pool 101. If the merchant identifier 212 is blocked, then the transaction 601 may be declined and an authorization decline message may be transmitted, such as to the acquirer 170.

If the merchant identifier 212 is not blocked, the data flow 600 may proceed to 604, in which a determination of whether the transaction 601 is a deceptive transaction is made. If the transaction 601 is not determined to be a deceptive transaction, then the transaction 601 may be approved and an authorization approve message may be transmitted, such as to the acquirer 170.

For example, the transaction classifier 122 may classify the transaction 601 as being a deceptive transaction. The transaction 601 and its classification as a deceptive transaction may be fed back to the transaction classifier 122. More particularly, the transaction 601 and its classification as a deceptive transaction may be used to refine training of the transaction classifier 122.

When a transaction is classified as being deceptive, the AI-based system 110 may identify merchants that submitted the deceptive transaction. For example, the data flow 600 may proceed to 606 in which the merchant identifier 212 may be recognized. In particular, the merchant recognizer 124 may use the N-density aware transaction (txn.) embedding 401 to recognize the merchant identifier 212.

Upon recognition of the merchant identifier 212 at 606, the data flow 600 may proceed to 608, in which a determination of whether the recognized merchant is a deceptive merchant is made. For example, the merchant classifier 126 may generate a merchant classification that classifies the recognized merchant as deceptive or non-deceptive. For example, the merchant identifier may be tagged as being associated with a deceptive merchant. The tagged merchant identifier may be fed back to the transaction classifier 122. More particularly, the tagged merchant identifier (indicating the merchant classification) may be used to refine training of the transaction classifier 122. In some examples, the tagged merchant identifier may be fed back to the merchant classifier 126. More particularly, the tagged merchant identifier may be used to refine training of the merchant classifier 126. In some examples, if the recognized merchant is classified as a deceptive merchant, the transaction 601 may be declined and an authorization decline message may be transmitted, such as to the acquirer 170. If the recognized merchant is classified as a non-deceptive merchant (indicating bad behavior rather than deceptiveness of the recognized merchant), a notification may be transmitted to the recognized merchant (such as through the acquirer 170) indicating that the transaction 601 is in the PCS listing 105.

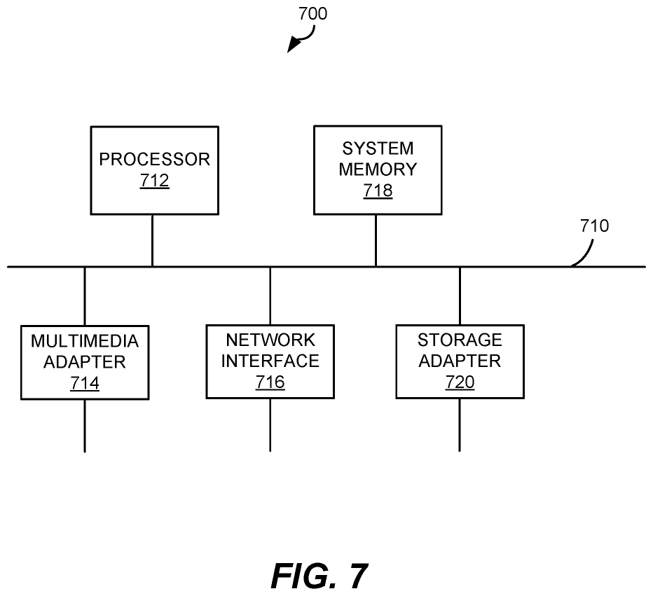

FIG. 7 illustrates an example of a computer system that may be implemented by devices illustrated in FIG. 1. Various ones of the devices of system environment 100 may be implemented based on some or all of the computer system 700. The computer system 700 may include, among other things, an interconnect 710, a processor 712, a multimedia adapter 714, a network interface 716, a system memory 718, and a storage adapter 720.

The interconnect 710 may interconnect various subsystems, elements, and/or components of the computer system 700. As shown, the interconnect 710 may be an abstraction that may represent any one or more separate physical buses, point-to-point connections, or both, connected by appropriate bridges, adapters, or controllers. In some examples, the interconnect 710 may include a system bus, a peripheral component interconnect (PCI) bus or PCI-Express bus, a HyperTransport or industry standard architecture (ISA)) bus, a small computer system interface (SCSI) bus, a universal serial bus (USB), IIC (I2C) bus, or an Institute of Electrical and Electronics Engineers (IEEE) standard 1384 bus, or “firewire,” or other similar interconnection element.

In some examples, the interconnect 710 may allow data communication between the processor 712 and system memory 718, which may include read-only memory (ROM) or flash memory (neither shown), and random-access memory (RAM) (not shown). It should be appreciated that the RAM may be the main memory into which an operating system and various application programs may be loaded. The ROM or flash memory may contain, among other code, the Basic Input-Output system (BIOS) which controls basic hardware operation such as the interaction with one or more peripheral components.

The processor 712 may control operations of the computer system 700. In some examples, the processor 712 may do so by executing instructions such as software or firmware stored in system memory 718 or other data via the storage adapter 720. In some examples, the processor 712 may be, or may include, one or more programmable general-purpose or special-purpose microprocessors, digital signal processors (DSPs), programmable controllers, application specific integrated circuits (ASICs), programmable logic device (PLDs), trust platform modules (TPMs), field-programmable gate arrays (FPGAs), other processing circuits, or a combination of these and other devices.

The multimedia adapter 714 may connect to various multimedia elements or peripherals. These may include devices associated with visual (e.g., video card or display), audio (e.g., sound card or speakers), and/or various input/output interfaces (e.g., mouse, keyboard, touchscreen).

The network interface 716 may provide the computer system 700 with an ability to communicate with a variety of remove devices over a network such as the communication network 107 illustrated in FIG. 1. The network interface 716 may include, for example, an Ethernet adapter, a Fibre Channel adapter, and/or other wired- or wireless-enabled adapter. The network interface 716 may provide a direct or indirect connection from one network element to another, and facilitate communication and between various network elements.

The storage adapter 720 may connect to a standard computer readable medium for storage and/or retrieval of information, such as a fixed disk drive (internal or external).

Other devices, components, elements, or subsystems (not illustrated) may be connected in a similar manner to the interconnect 710 or via a network such as the communication network 107. The devices and subsystems can be interconnected in different ways from that shown in FIG. 7. Instructions to implement various examples and implementations described herein may be stored in computer-readable storage media such as one or more of system memory 718 or other storage. Instructions to implement the present disclosure may also be received via one or more interfaces and stored in memory. The operating system provided on computer system 700 may be MS-DOS®, MS-WINDOWS®, OS/2®, OS X®, IOS®, ANDROID®, UNIX®, Linux®, or another operating system.

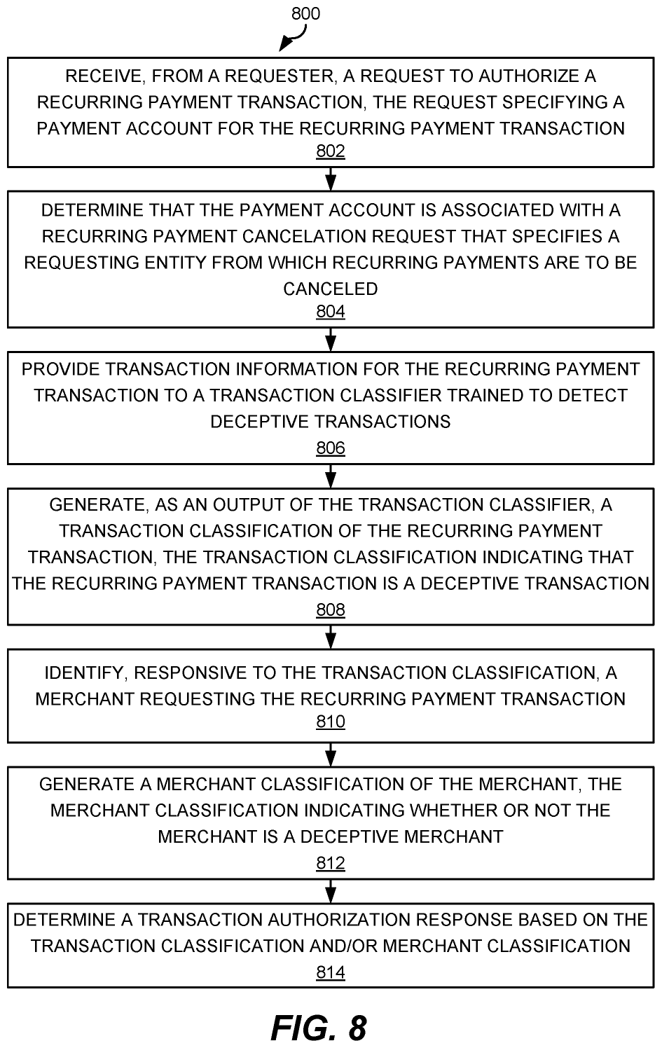

FIG. 8 illustrates an example of an AI-based method 800 of applying machine-learning to process recurring payment transactions. Although recurring payment transactions are illustrated in the example method 800, other types of transactions may be processed. At 802, the method 800 may include receiving, from a requester, a request to authorize a recurring payment transaction, the request specifying a payment account for the recurring payment transaction.

At 804, the method 800 may include determining that the payment account (such as a payment account 133) is associated with a payment cancelation request that specifies a requesting entity (which may be identified by a merchant identifier 212 and/or acquirer identifier 214) from which recurring payments are to be canceled.

In some examples, after 804 and before 806, the method 800 may include consulting a pool of blocked merchants and acquirers (such as the merchant-acquirer pool 101) to determine whether the merchant is to be blocked. The pool of blocked merchants and acquirers may include merchant identifiers and acquirer identifiers of acquirers used by respective merchants in the pool of blocked merchants and acquirers.

At 806, the method 800 may include providing transaction information for the recurring payment transaction to a transaction classifier (such as the transaction classifier 122) trained to detect deceptive transactions. In some examples, the transaction classifier may include an OCC trained based on training data (such as training data 201). The training data may include transaction features of transactions, each transaction of the transactions being labeled as being associated with a transaction chargeback and/or other indication of being a deceptive transaction.

In some examples, the transaction classifier is trained through a GAN (such as the GAN 300), which may include a generator (such as generator 302) to introduce deviations in one or more of the transaction features in the training data and a discriminator (such as discriminator 304) to generate a probability that the output of the generator deviates from the training data, wherein the transaction classification is based on the probability.

At 808, the method 800 may include generating, as an output of the transaction classifier, a transaction classification of the recurring payment transaction, the transaction classification indicating that the recurring payment transaction is a deceptive transaction.

At 810, the method 800 may include identifying, responsive to the transaction classification, a merchant requesting the recurring payment transaction. For example, the method 800 may include applying transaction data to an N-class density aware transaction embedding (such as the N-class density aware transaction embedding 401) and identifying the merchant based on the N-class density aware embedding.

At 812, the method 800 may include generating a merchant classification of the merchant, the merchant classification indicating whether or not the merchant is a deceptive merchant. In some examples, generating the merchant classification may include applying information known about the merchant to a multi-class density aware embedding (such as the 2-class density aware embedding 501) comprising a first embedding associated with deceptive merchants (such as M_{D}) and a second embedding associated with non-deceptive merchants (such as M_{ND}). In some examples, generating the merchant classification may include generating, for the merchant, a first similarity score (such as a WMD_{D}) associated with the first embedding and generating, for the merchant, a second similarity score (such as WMD_{ND}) associated with the second embedding and generating a classification score (such as C in equation (1)) based on the first similarity score and the second similarity score. The merchant classification may be based on the classification score.

In some examples, the merchant classification may include a first classification associated with the first embedding, indicating that the merchant is a deceptive merchant. In these examples, the method 800 may include storing an indication of the first classification of the merchant to inform future recurring payment transactions associated with the merchant. For example, the first classification that the merchant is a deceptive merchant may be used as feedback to refine training of the transaction classifier.

In some examples, the merchant classification may include a second classification associated with the second embedding, indicating that the merchant is a non-deceptive merchant. In these examples, the method 800 may include transmit a notification to the merchant indicating that recurring payment transactions from the merchant involving the payment account has been canceled. The notification may be made via an authorization decline message, and a reason indicating that the payment transaction is subject to the PCS listing 105. The method 800 may further including storing an indication of the second classification of the merchant to inform future recurring payment transactions associated with the merchant. For example, the second classification that the merchant is a non-deceptive merchant may be used as feedback to refine training of the transaction classifier.

At 814, the method 800 may include determining a transaction authorization response based on the transaction classification and/or merchant classification. For example, if the transaction and/or the merchant is classified as being deceptive, then the transaction authorization response may be an authorization decline message. Otherwise, the transaction authorization response may be an authorization approve message.

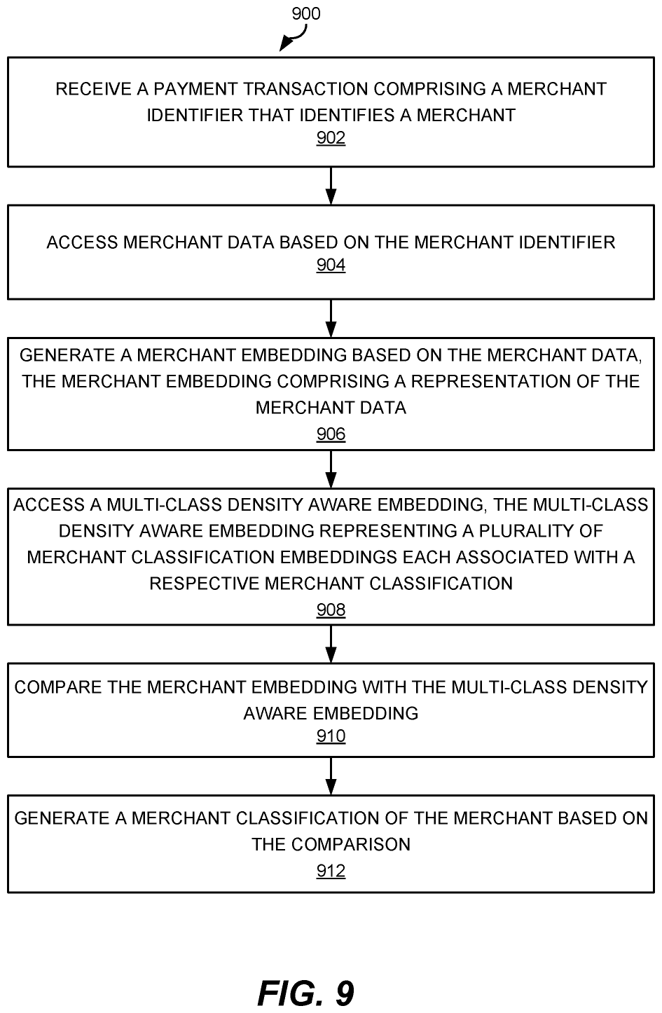

FIG. 9 illustrates an example method 900 of classifying merchants (such as merchants 180). At 902, the method 900 may include receiving a payment transaction comprising a merchant identifier (such as a merchant identifier 212) that identifies a merchant (such as a merchant 180). At 904, the method 900 may include accessing merchant data based on the merchant identifier. For example, the merchant data may be accessed from the merchant-acquirer pool 101, transaction database 103, PCS listing 105, and/or other sources of data known about merchants. At 906, the method 900 may include generating a merchant embedding (such as M₀ illustrated in FIG. 5) based on the merchant data, the merchant embedding comprising a representation of the merchant data. At 908, the method 900 may include accessing a multi-class density aware embedding (such as the embedding 501), the multi-class density aware embedding representing a plurality of merchant classification embeddings (such as M_{D} and M_{ND} illustrated in FIG. 5) each associated with a respective merchant classification.

At 910, the method 900 may include comparing the merchant embedding with the multi-class density aware embedding. For example, the method 900 may include generating a plurality of similarity scores (such as WMD_{D} and WMD_{ND}) based on the merchant embedding and the multi-class density aware embedding. Each similarity score of the plurality of similarity scores may indicate a level of similarity between the merchant and a respective merchant classification embedding. The method 900 may further include generating the classification of the merchant based on the plurality of similarity scores. At 912, the method 900 may include generating a merchant classification of the merchant based on the comparison. In some examples, the method 900 may further include accessing feedback information comprising merchant classifications and revising the multi-class density aware embedding based on the merchant classifications.

It should be noted that AI and machine-learning as generally described herein throughout may refer to various types of systems that involve training, validating, and using intelligent behavior in computers. For example, broadly speaking, AI may include systems, programmed by computer instructions, that is improved to act “intelligently” in a manner that is able to learn from observations. Machine-learning may include particular computational training of computer systems so that computers may learn from observed data to alter their behavior. Machine-learning may include deep learning techniques, which may involve training a computer based on labels. In various examples, the labels may include labels of what constitutes “deceptive transactions” or “deceptive merchants.” The systems may further correlate deeper layers that incorporate features such as transaction parameters and/or data known about merchants to make identify relationships between the features with the labels. In this manner, deep learning techniques may model multiple layers of features with labels to generate probabilistic classifications of deceptive transactions or deceptive merchants. Likewise, deep learning techniques may learn embeddings to identify aspects of merchants that facilitate intelligent recognition of a merchant based on the learned embeddings. Such embeddings may be used to intelligently recognize merchants by comparison to known merchants and/or to classify whether a given merchant is deceptive based on comparison to known merchants who are deceptive.

Throughout the disclosure, the terms “a” and “an” may be intended to denote at least one of a particular element. As used herein, the term “includes” means includes but not limited to, the term “including” means including but not limited to. The term “based on” means based at least in part on. In the Figures, the use of the letter “N” to denote plurality in reference symbols is not intended to refer to a particular number.

The databases described herein may be, include, or interface to, for example, an Oracle™ relational database sold commercially by Oracle Corporation. Other databases, such as Informix™, DB2 or other data storage, including file-based, or query formats, platforms, or resources such as OLAP (On Line Analytical Processing), SQL (Structured Query Language), a SAN (storage area network), Microsoft Access™ or others may also be used, incorporated, or accessed. The database may comprise one or more such databases that reside in one or more physical devices and in one or more physical locations. The database may include cloud-based storage solutions. The database may store a plurality of types of data and/or files and associated data or file descriptions, administrative information, or any other data. The various databases may store predefined and/or customized data described herein.

The components of the system environment 100 illustrated in FIG. 1 may be connected to one another via a communication network (not illustrated), which may include the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, and/or other network through which system environment 100 components may communicate.

The systems and processes are not limited to the specific embodiments described herein. In addition, components of each system and each process can be practiced independent and separate from other components and processes described herein. Each component and process also can be used in combination with other assembly packages and processes. The flow charts and descriptions thereof herein should not be understood to prescribe a fixed order of performing the method blocks described therein. Rather the method blocks may be performed in any order that is practicable including simultaneous performance of at least some method blocks. Furthermore, each of the methods may be performed by one or more of the system components illustrated in the figures.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

As will be appreciated based on the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. Example computer-readable media may be, but are not limited to, a flash memory drive, digital versatile disc (DVD), compact disc (CD), fixed (hard) drive, diskette, optical disk, magnetic tape, semiconductor memory such as read-only memory (ROM), and/or any transmitting/receiving medium such as the Internet or other communication network or link. By way of example and not limitation, computer-readable media comprise computer-readable storage media and communication media. Computer-readable storage media are tangible and non-transitory and store information such as computer-readable instructions, data structures, program modules, and other data. Communication media, in contrast, typically embody computer-readable instructions, data structures, program modules, or other data in a transitory modulated signal such as a carrier wave or other transport mechanism and include any information delivery media. Combinations of any of the above are also included in the scope of computer-readable media. The article of manufacture containing the computer code may be made and/or used by executing the code directly from one medium, by copying the code from one medium to another medium, or by transmitting the code over a network.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system of applying machine-learning to process recurring payment transactions, comprising:
a processor programmed to:
receive, from a requester, a request to authorize a recurring payment transaction, the request specifying a payment account for the recurring payment transaction;
determine that the payment account is associated with a recurring payment cancelation request that specifies a requesting entity from which recurring payments are to be canceled;
provide transaction information for the recurring payment transaction to a transaction classifier trained to detect transaction anomalies indicative of deceptive transactions;
generate, as an output of the transaction classifier, a transaction classification of the recurring payment transaction, the transaction classification indicating that the recurring payment transaction is a deceptive transaction;
identify, responsive to the transaction classification, a merchant requesting the recurring payment transaction;
generate a merchant classification of the merchant, the merchant classification indicating whether or not the merchant is a deceptive merchant; and
determine a transaction authorization response based on the transaction classification and/or merchant classification.

2. The system of claim 1, wherein the transaction classifier comprises a one-class classifier (OCC) trained based on training data comprising transaction features of transactions, each transaction of the transactions being labeled as being associated with a transaction chargeback.

3. The system of claim 2, wherein the transaction classifier is trained through a generative adversarial network (GAN) comprising a generator to introduce deviations in one or more of the transaction features in the training data and a discriminator to generate a probability that the output of the generator deviates from the training data, wherein the transaction classification is based on the probability.

4. The system of claim 1, wherein to identify the merchant, the processor is programmed to:
apply transaction data to an N-class density aware transaction embedding, wherein N is equal to a number of known merchants; and
identify the merchant based on the N-class density aware transaction embedding.

5. The system of claim 1, wherein to generate the merchant classification, the processor is further programmed to:
apply information known about the merchant to a multi-class density aware embedding comprising a first embedding associated with deceptive merchants and a second embedding associated with non-deceptive merchants.

6. The system of claim 5, wherein to generate the merchant classification, the processor is further programmed to:
generate, for the merchant, a first similarity score associated with the first embedding;
generate, for the merchant, a second similarity score associated with the second embedding; and
generate a classification score based on the first similarity score and the second similarity score, wherein the merchant classification is based on the classification score.

7. The system of claim 6, wherein the merchant classification comprises a first classification associated with the first embedding, indicating that the merchant is a deceptive merchant, and wherein the processor is further programmed to:
store an indication of the first classification of the merchant to inform future recurring payment transactions associated with the merchant.

8. The system of claim 6, wherein the merchant classification comprises a second classification associated with the second embedding, indicating that the merchant is a non-deceptive merchant, and wherein the processor is further programmed to:
transmit a notification to the merchant indicating that recurring payment transactions from the merchant involving the payment account has been canceled; and
store an indication of the second classification of the merchant to inform future recurring payment transactions associated with the merchant.

9. The system of claim 1, wherein the processor is further programmed to:
prior to generation of the transaction classification of the recurring payment transaction, consult a pool of blocked merchants and acquirers to determine whether the merchant is to be blocked, the pool of blocked merchants and acquirers comprising a merchant identifiers and acquirer identifiers of acquirers used by respective merchants in the pool of blocked merchants and acquirers,
wherein the recurring payment transaction is classified responsive to a determination that the merchant is not among the pool of blocked merchants and acquirers.

10. The system of claim 9, wherein the processor is further programmed to:
generate the pool of blocked merchants and acquirers based on merchant aggregation in which merchant identifiers are matched through entity matching.

11. A method of applying machine-learning to process recurring payment transactions, comprising:
receiving, by a processor, from a requester, a request to authorize a recurring payment transaction, the request specifying a payment account for the recurring payment transaction;
determining, by the processor, that the payment account is associated with a recurring payment cancelation request that specifies a requesting entity from which recurring payments are to be canceled;
providing, by the processor, transaction information for the recurring payment transaction to a transaction classifier trained to detect transaction anomalies indicative of deceptive transactions;
generating, by the processor, as an output of the transaction classifier, a transaction classification of the recurring payment transaction, the transaction classification indicating that the recurring payment transaction is a deceptive transaction;
identifying, by the processor, responsive to the transaction classification, a merchant requesting the recurring payment transaction;
generating, by the processor, a merchant classification of the merchant, the merchant classification indicating whether or not the merchant is a deceptive merchant; and
determining, by the processor, a transaction authorization response based on the transaction classification and/or merchant classification.

12. The method of claim 11, wherein to generating the merchant classification comprises:
apply information known about the merchant to a multi-class density aware embedding comprising a first embedding associated with deceptive merchants and a second embedding associated with non-deceptive merchants.

13. The method of claim 12, wherein generating the merchant classification comprises:
generate, for the merchant, a first similarity score associated with the first embedding;
generate, for the merchant, a second similarity score associated with the second embedding; and
generate a classification score based on the first similarity score and the second similarity score, wherein the merchant classification is based on the classification score.

14. The method of claim 13, wherein the merchant classification comprises a first classification associated with the first embedding, indicating that the merchant is a deceptive merchant, and wherein the method further comprising:
storing an indication of the first classification of the merchant to inform future recurring payment transactions associated with the merchant.

15. The method of claim 13, wherein the merchant classification comprises a second classification associated with the second embedding, indicating that the merchant is a non-deceptive merchant, and wherein the method further comprising:
transmitting a notification to the merchant indicating that recurring payment transactions from the merchant involving the payment account has been canceled; and
storing an indication of the second classification of the merchant to inform future recurring payment transactions associated with the merchant.

16. A system to classify merchants, comprising:
a processor programmed to:
receive a payment transaction comprising a merchant identifier that identifies a merchant;
access merchant data based on the merchant identifier;
generate a merchant embedding based on the merchant data, the merchant embedding comprising a representation of the merchant data;
access a multi-class density aware embedding, the multi-class density aware embedding representing a plurality of merchant classification embeddings each associated with a respective merchant classification;
compare the merchant embedding with the multi-class density aware embedding; and
generate a merchant classification of the merchant based on the comparison.

17. The system of claim 16, wherein to compare the merchant embedding with the multi-class density aware embedding, the processor is further programmed to:
generate a plurality of similarity scores based on the merchant embedding and the multi-class density aware embedding, each similarity score of the plurality of similarity scores indicating a level of similarity between the merchant and a respective merchant classification embedding; and
generate the classification of the merchant based on the plurality of similarity scores.

18. The system of claim 16, wherein the multi-class density aware embedding comprises a 2-class density aware embedding comprising a first embedding representing a deceptive classification and a second embedding representing a non-deceptive classification merchants, and wherein to compare the merchant embedding with the multi-class density aware embedding, the processor is further programmed to:
generate, for the merchant, a first similarity score associated with the first embedding;
generate, for the merchant, a second similarity score associated with the second embedding; and
generate a classification score based on the first similarity score and the second similarity score, wherein the merchant classification is based on the classification score.

19. The system of claim 18, wherein to generate the classification score, the processor is further programmed to:
divide the first similarity score by the second similarity score; and
wherein to generate the merchant classification, the processor is further programmed to:
compare the classification score to a threshold value, wherein the merchant classification is generated based on the comparison.

20. The system of claim 16, wherein the processor is further programmed to:
access feedback information comprising merchant classifications; and
revise the multi-class density aware embedding based on the merchant classifications.
